(19) United States
(12) Patent Application Publication
(10) Pub. No.: US 2025/0087775 A1
(43) Pub. Date: Mar. 13, 2025

(54) FLOW BATTERY DEGASSING DEVICE, DEGASSING METHOD, SYSTEM AND STORAGE MEDIUM

(71) Applicant: VRB Energy Inc., Grand Cayman (KY)

(72) Inventors: Shuai Dong, Beijing (CN); Qiming Ge, Beijing (CN); Huichao Liu, Beijing (CN); Yu Zhang, Beijing (CN); Dehao Wang, Beijing (CN); Zhiwei Duan, Beijing (CN); Yongkai Han, Beijing (CN)

(21) Appl. No.: 18/741,180

(22) Filed: Jun. 12, 2024

(30) Foreign Application Priority Data
Sep. 7, 2023 (CN) 202311154043.0

(51) Int. Cl. H01M 10/44; H01M 10/6556; H01M 10/6567

(52) U.S. Cl. CPC H01M 10/445; H01M 10/6556; H01M 10/6567

(57) ABSTRACT

Disclosed are a flow battery degassing device, a degassing method, a system, and a storage medium. The flow battery includes a liquid tank. The flow battery degassing device includes a degassing tank, a degassing pump, a liquid outlet pipe, and a liquid inlet pipe. The liquid outlet pipe is configured to enable an electrolyte in the liquid tank to flow into the degassing tank. The liquid inlet pipe is configured to enable the electrolyte in the degassing tank to flow into the liquid tank. The degassing pump is provided on the liquid inlet pipe and configured to form a vacuum environment in the degassing tank.

### RELATED APPLICATIONS

This application claims priority to Chinese Patent Application No. 202311154043.0, filed Sep. 7, 2023, and titled FLOW BATTERY DEGASSING DEVICE, DEGASSING METHOD, SYSTEM AND STORAGE MEDIUM, which is incorporated herein by reference in its entirety.

### TECHNICAL FIELD

The present application relates to, but is not limited to, the field of electrochemical energy storage, and in particular relates to a flow battery degassing device, a degassing method, a system, and a storage medium.

### BACKGROUND

With the development of society and the economy, the demand for new energy continues to increase, promoting the development of the energy storage industry. Flow batteries achieve the mutual conversion of electric energy and chemical energy through reversible redox reactions (i.e., reversible changes in valence states) of active substances in positive and negative electrolytes. Due to the excellent stability and safety, flow batteries have become the mainstream technical solution in the field of energy storage.

The inventor of the present invention has found through research that the gas content in the electrolyte of the flow battery has a significant influence on the operation of the flow battery. However, at present, it is difficult to degas the electrolyte.

### SUMMARY

The following is a summary of the subject matter described in detail herein. This summary is not intended to limit the scope of protection of the claims.

An embodiment of the present application provides a flow battery degassing device, a degassing method, a system, and a storage medium, which can solve the problem that it is difficult to degas the electrolyte.

In a first aspect, an embodiment of the present application provides a flow battery degassing device, a flow battery including a liquid tank, the flow battery degassing device including a degassing tank, a degassing pump, a liquid outlet pipe and a liquid inlet pipe, the liquid outlet pipe being configured to enable an electrolyte in the liquid tank to flow into the degassing tank, the liquid inlet pipe being configured to enable the electrolyte in the degassing tank to flow into the liquid tank; the degassing pump being provided on the liquid inlet pipe and configured to form a vacuum environment in the degassing tank.

In an exemplary embodiment, the flow battery degassing device further includes a switching device, the switching device includes a check valve provided on the liquid inlet pipe, and the check valve is located downstream of the degassing pump along a flow direction of the electrolyte and configured to prevent the degassed electrolyte from flowing back to the degassing tank.

In an exemplary embodiment, the switching device further includes a first switch provided on the liquid outlet pipe and configured to control the electrolyte to enter the degassing tank.

In an exemplary embodiment, the flow battery degassing device further includes a control device, and the control device is configured to receive a gas content value of the electrolyte in the flow battery and control the degassing pump and the switching device to work to degas the electrolyte in a case that the gas content value is greater than or equal to a first threshold.

In an exemplary embodiment, the flow battery degassing device further includes a gas detection device configured to detect the gas content value of the electrolyte in the flow battery and transmit the detected gas content value to the control device.

In an exemplary embodiment, the flow battery degassing device further includes a flow rate detection device configured to detect a flow rate value of the electrolyte entering the degassing tank and transmit the detected flow rate value of the electrolyte to the control device; the control device is further configured to control the first switch to be turned off after the flow rate value of the electrolyte is greater than or equal to a first set value.

In an exemplary embodiment, the flow battery degassing device further includes a heat exchange device; the heat exchange device includes a heat exchanger and a refrigerant machine, the heat exchanger is configured to cool the electrolyte, and the refrigerant machine is configured to provide a refrigerant to the heat exchanger.

In an exemplary embodiment, the heat exchanger is provided in the degassing tank, and the electrolyte flows through the heat exchanger to a bottom of the degassing tank after entering the degassing tank.

In an exemplary embodiment, a plurality of heat exchange tubes are provided in the heat exchanger, the heat exchange tubes are connected with the refrigerant machine, and the refrigerant flows in the heat exchange tubes; a bottom of the heat exchanger is provided with a spray pipe, the electrolyte enters the heat exchanger from one end of the spray pipe, and the spray pipe is configured to enable the electrolyte to come into contact with the heat exchange tubes.

In an exemplary embodiment, the plurality of heat exchange tubes are arranged in layers from bottom to top in the heat exchanger.

In an exemplary embodiment, the control device is further configured to receive a temperature value of the electrolyte in the flow battery and control the heat exchange device to work to cool the electrolyte in a case that the temperature value is greater than or equal to a second threshold.

In an exemplary embodiment, the flow battery degassing device further includes a temperature detection device configured to detect the temperature value of the electrolyte in the flow battery and transmit the detected temperature value to the control device.

In a second aspect, an embodiment of the present application further provides a flow battery degassing system, including a flow battery and the flow battery degassing device described above.

In a third aspect, an embodiment of the present application further provides a flow battery degassing method, a flow battery including a liquid tank, the method including: using a degassing tank to form a vacuum environment in a degassing tank; controlling an electrolyte in the liquid tank to flow into the degassing tank along a liquid outlet pipe; and controlling the degassed electrolyte to flow back to the liquid tank along a liquid inlet pipe, the degassing pump being provided on the liquid inlet pipe.

In a fourth aspect, an embodiment of the present application further provides a computer-readable storage medium storing computer-executable instructions used for performing the flow battery degassing method described above.

The flow battery degassing device provided in the embodiment of the present application utilizes the degassing pump to form a vacuum environment in the degassing tank. The electrolyte in the liquid tank of the flow battery can enter the degassing tank, complete degassing in the vacuum environment, and return to the liquid tank, so that the gas in the electrolyte will not be adsorbed on the stack unit, thus ensuring the flow rate of the electrolyte and the charging and discharging reaction efficiency, keeping the stack unit at a relatively high operation efficiency, and ensuring the operation reliability of the stack unit. The flow battery degassing device provided in the embodiment of the present application can perform degassing treatment on the basis of normal operation of the flow battery, thus ensuring the working efficiency of the flow battery. The problem that it is difficult to degas the electrolyte is solved.

Other features and advantages of the present application will be set forth in the following description, and in part will become apparent from the description, or may be understood by means of the implementation of the present application. Other advantages of the present application will be achieved and attained by means of the solutions described in the description and the accompanying drawings.

After reading and understanding the drawings and detailed descriptions, other aspects can be understood.

### BRIEF DESCRIPTION OF THE DRAWINGS

The accompanying drawings are used to provide an understanding of the technical solutions of the present application and constitute a part of the specification, and together with the embodiments of the present application, are used to explain the technical solution of the present application and not to limit the technical solution of the present application.

FIG. 1 illustrates a schematic diagram of a flow battery.

FIG. 2 illustrates a schematic diagram of a flow battery degassing device according to an exemplary embodiment.

FIG. 3 illustrates a schematic diagram of some components of the flow battery degassing device in FIG. 2.

FIG. 4 illustrates a schematic diagram of a degassing tank and a heat exchanger according to an exemplary embodiment.

FIG. 5 illustrates a schematic diagram of a method for degassing and cooling by adopting a flow battery degassing device according to an exemplary embodiment.

### DETAILED DESCRIPTION

A plurality of embodiments are described in the present application. However, the description is exemplary rather than limiting, and it will be apparent to those skilled in the art that more embodiments and implementations are possible within the scope encompassed by the embodiments described in the present application. Although many possible combinations of features are shown in the drawings and discussed in the specific embodiments, many other combinations of the disclosed features are also possible. Unless otherwise restricted, any feature or element of any embodiment may be used in combination with or in place of any other feature or element of any other embodiment.

The embodiment of the present application includes and envisions combinations of features and components known to those skilled in the art. The embodiments, features, and components already disclosed in the present application may also be combined with any conventional features or components to form a unique invention solution as defined by the claims. Any feature or element of any embodiment may also be combined with features or elements from other invention solutions to form another unique invention solution as defined by the claims. Therefore, it should be understood that any features shown and/or discussed in the present application may be implemented individually or in any appropriate combination. Therefore, the embodiments are not subject to any other limitations except those imposed by the attached claims and their equivalent replacements. In addition, various modifications and changes may be made within the scope of protection of the attached claims.

Besides, when describing representative embodiments, the description may already present the method and/or process as a specific sequence of steps. However, to the extent that the method or process does not rely on a specific order of steps described herein, the method or process should not be limited to the specific order of steps described. As those skilled in the art will understand, other orders of steps are also possible. Therefore, the specific order of steps described in the description should not be interpreted as a limitation on the claims. In addition, the claims regarding the method and/or process should not be limited to performing the steps in the written orders. Those skilled in the art can easily understand that variations may be made to these orders, which still fall within the spirit and scope of the embodiments of the present application.

A flow battery is a high-performance energy storage battery that separates positive and negative electrolytes and cycles them separately. The electrolytes contain active substances, which flow with the positive and negative electrolytes and undergo reversible redox reactions, allowing the flow battery to complete the charging and discharging processes. According to the different active substances contained in the electrolytes, flow batteries can be divided into: all-vanadium flow batteries, iron-chromium flow batteries, zinc-bromine flow batteries, sodium polysulfide/bromine flow batteries, zinc/nickel flow batteries, etc. As an electrochemical energy storage technology, flow batteries have the characteristics of high capacity, wide range of applications, and long cycle life.

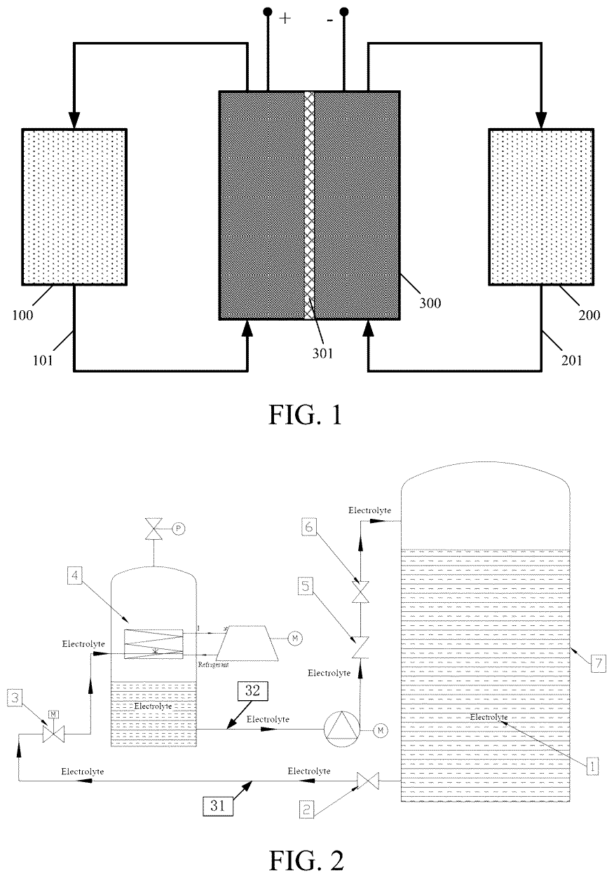

FIG. 1 illustrates a schematic diagram of a flow battery. Referring to FIG. 1, a flow battery includes a positive liquid tank 100, a negative liquid tank 200, and a stack unit 300. The positive liquid tank 100 contains a positive electrolyte. The positive electrolyte circulates between the positive liquid tank 100 and the stack unit 300 through a positive pipeline 101. The positive liquid tank 100, the positive pipeline 101, and the stack unit 300 form a circulation loop for the positive electrolyte. A flow direction of the positive electrolyte in the circulation loop may be as shown by the arrow direction of the positive pipeline 101 in FIG. 1. The negative liquid tank 200 contains a negative electrolyte. The negative electrolyte circulates between the negative liquid tank 200 and the stack unit 300 through a negative pipeline 201. The negative liquid tank 200, the negative pipeline 201, and the stack unit 300 form a circulation loop for the negative electrolyte. A flow direction of the negative electrolyte in the circulation loop may be as shown by the arrow direction of the negative pipeline 201 in FIG. 1. A separator 301 may be provided in the stack unit 300 to prevent the positive electrolyte and the negative electrolyte from mixing. The stack unit 300 has a positive electrode (+) and a negative electrode (−), which can be connected to an external power source or load to achieve charging and discharging. In the process of flowing through the stack unit 300, the electrolyte undergoes oxidation or reduction reaction. In the charging process of the flow battery, the positive electrolyte undergoes oxidation reaction, causing an increase in the valence state of the active substances, while the negative electrolyte undergoes reduction reaction, causing a decrease in the valence state of the active substance. The discharging process is the opposite. The flow battery achieves the separation of the electrochemical reaction site (stack unit) and the energy storage active substances in space, and the battery power and capacity design are relatively independent. Compared with the energy storage means such as lithium batteries, pumped storage, and air-compressed storage, the flow batter has superior performance in terms of load capacity, long-term discharge capacity, and durability. Therefore, it is suitable for large-scale energy storage systems such as wind and photovoltaic power generation.

During the initial operation of the flow battery, it is necessary to control the continuous flow of the electrolytes in the respective circulation loops to exhaust the air accumulated in the pipeline and stack unit. Subsequently, the flow battery can operate normally. Under normal operation, the circulation loops of the electrolytes need to maintain a certain vacuum environment. However, in practical application, the air accumulated in the pipeline and stack unit is not easily exhausted completely. Moreover, hydrogen evolution, oxygen evolution, and other reactions often occur at the reaction interface between the stack unit and the positive and negative electrolytes. Some of the hydrogen and oxygen produced by the reactions will be adsorbed on the solid-liquid interface, while the other will be dissolved in the electrolyte. As the electrolytes continue to circulate, the vacuum environment of the flow battery will change.

The inventor of the present invention has found in practice that the gas content in the electrolyte of the flow battery has a significant influence on the operation of the flow battery. After the hydrogen evolution reaction occurs, the content of hydrogen ions in the electrolyte will decrease, leading to the loss of hydrogen ions in the charging and discharging process, resulting in a decrease in the capacity of the flow battery. The hydrogen and oxygen adsorbed on the solid-liquid interface will occupy the reaction area of the electrolyte for charging and discharging, resulting a decrease in the Coulombic efficiency and energy efficiency of the battery. For the gas dissolved in the electrolyte, this part of gas exists in the form of bubbles in the pipeline. When the gas content is too high, it will influence the vacuum degree of the normal operation of the electrolyte, causing cavitation. Cavitation will cause noise and vibration during the operation of the flow battery, resulting in a decrease in the flow rate of the electrolyte and the charging and discharging reaction efficiency, leading to corrosion of metal materials in contact with the electrolyte. In the pipeline where the electrolyte enters the liquid tank from the stack unit, due to the increase in pressure inside the pipeline, some bubbles will be dissolved. After the bubbles are condensed, heat will be released, which easily causes chemical corrosion. The gas partially dissolved in the electrolyte will be precipitated from the electrolyte after entering the liquid tank and gather above the liquid tank. If the hydrogen gathers too much and reaches a critical concentration value, it is easy to cause safety accidents. However, there is currently a lack of effective means for degassing the electrolyte.

An embodiment of the present application provides a flow battery degassing device. A flow battery includes a liquid tank. The flow battery degassing device includes a degassing tank, a degassing pump, a liquid outlet pipe and a liquid inlet pipe. The liquid outlet pipe is configured to enable an electrolyte in the liquid tank to flow into the degassing tank. The liquid inlet pipe is configured to enable the electrolyte in the degassing tank to flow into the liquid tank. The degassing pump is provided on the liquid inlet pipe and configured to form a vacuum environment in the degassing tank.

The flow battery degassing device provided in the embodiment of the present application utilizes the degassing pump to form a vacuum environment in the degassing tank. The electrolyte in the liquid tank of the flow battery can enter the degassing tank, complete degassing in the vacuum environment, and return to the liquid tank, so that the gas in the electrolyte will not be adsorbed on the stack unit, thus ensuring the flow rate of the electrolyte and the charging and discharging reaction efficiency, keeping the stack unit at a relatively high operation efficiency, and ensuring the operation reliability of the stack unit. The flow battery degassing device provided in the embodiment of the present application can perform degassing treatment on the basis of normal operation of the flow battery, thus ensuring the working efficiency of the flow battery.

In an exemplary embodiment, the flow battery degassing device further includes a switching device, the switching device includes a check valve provided on the liquid inlet pipe, and the check valve is located downstream of the degassing pump along a flow direction of the electrolyte and configured to prevent the degassed electrolyte from flowing back to the degassing tank.

In an exemplary embodiment, the switching device further includes a first switch provided on the liquid outlet pipe and configured to control the electrolyte to enter the degassing tank.

In an exemplary embodiment, the flow battery degassing device further includes a control device, and the control device is configured to receive a gas content value of the electrolyte in the flow battery and control the degassing pump and the switching device to work to degas the electrolyte in a case that the gas content value is greater than or equal to a first threshold.

In an exemplary embodiment, the flow battery degassing device further includes a gas detection device configured to detect the gas content value of the electrolyte in the flow battery and transmit the detected gas content value to the control device.

In an exemplary embodiment, the flow battery degassing device further includes a flow rate detection device configured to detect a flow rate value of the electrolyte entering the degassing tank and transmit the detected flow rate value of the electrolyte to the control device; the control device is further configured to control the first switch to be turned off after the flow rate value of the electrolyte is greater than or equal to a first set value.

In an exemplary embodiment, the flow battery degassing device further includes a heat exchange device; the heat exchange device includes a heat exchanger and a refrigerant machine, the heat exchanger is configured to cool the electrolyte, and the refrigerant machine is configured to provide a refrigerant to the heat exchanger.

In an exemplary embodiment, the heat exchanger is provided in the degassing tank, and the electrolyte flows through the heat exchanger to a bottom of the degassing tank after entering the degassing tank.

In an exemplary embodiment, a plurality of heat exchange tubes are provided in the heat exchanger, the heat exchange tubes are connected with the refrigerant machine, and the refrigerant flows in the heat exchange tubes; a bottom of the heat exchanger is provided with a spray pipe, the electrolyte enters the heat exchanger from one end of the spray pipe, and the spray pipe is configured to enable the electrolyte to come into contact with the heat exchange tubes.

In an exemplary embodiment, the plurality of heat exchange tubes are arranged in layers from bottom to top in the heat exchanger.

In an exemplary embodiment, the control device is further configured to receive a temperature value of the electrolyte in the flow battery and control the heat exchange device to work to cool the electrolyte in a case that the temperature value is greater than or equal to a second threshold.

In an exemplary embodiment, the flow battery degassing device further includes a temperature detection device configured to detect the temperature value of the electrolyte in the flow battery and transmit the detected temperature value to the control device.

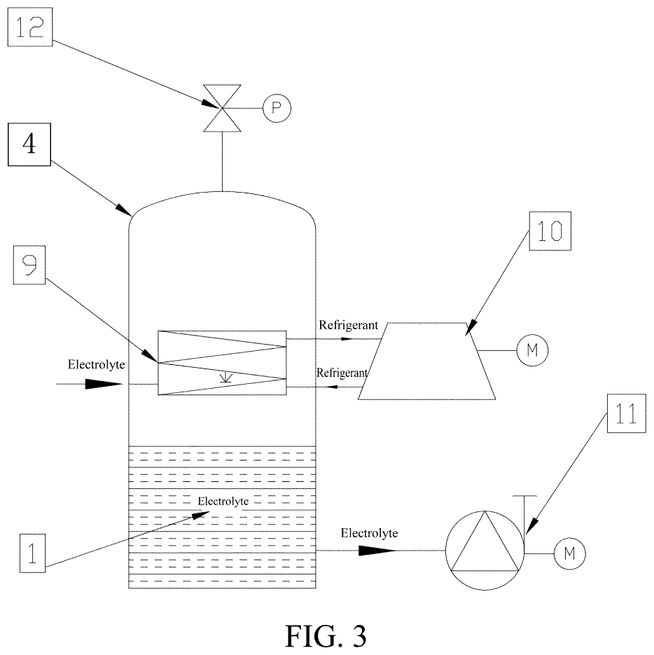

FIG. 2 illustrates a schematic diagram of a flow battery degassing device according to an exemplary embodiment, which is a simplified illustration of the flow battery. FIG. 3 illustrates a schematic diagram of some components of the flow battery degassing device in FIG. 2. Referring to FIG. 2 and FIG. 3, the flow battery includes a liquid tank 7. The liquid tank 7 may be a positive or negative liquid tank. The liquid tank 7 is provided with a first outlet and a first inlet. The first outlet may be located at a lower part of the liquid tank 7. The first inlet may be located at an upper part of the liquid tank 7. The flow battery degassing device includes a degassing tank 4. The degassing tank 4 is provided a second outlet and a second inlet. The second outlet may be located below the degassing tank 4. The second inlet may be located above the second outlet. The flow battery degassing device includes a liquid outlet pipe 31 and a liquid inlet pipe 32. The liquid outlet pipe 31 is connected with the first outlet of the liquid tank 7 and the second inlet of the degassing tank 4, which can allow the electrolyte to flow out of the liquid tank 7. The liquid inlet pipe 32 is connected with the first inlet of the liquid tank 7 and the second outlet of the degassing tank 4, which can allow the electrolyte to flow into the liquid tank 7. A degassing pump 11 is provided on the liquid inlet pipe 31. The degassing pump 11 can form a vacuum environment in the degassing tank 4 to facilitate the degassing treatment of the electrolyte. The liquid tank 7, the liquid outlet pipe 31, the degassing tank 4, and the liquid inlet pipe 32 form a circulation loop. Under the action of the degassing pump 11, an electrolyte 1 can return to the liquid tank 7 after degassed from the degassing tank 4. In an exemplary embodiment, when the gas content in the electrolyte 1 is greater than or equal to the preset first threshold, the flow battery degassing device may be turned on to degas the electrolyte 1. The degassed electrolyte 1 may return to the liquid tank 7 in time without influencing the normal operation of the flow battery. That is to say, the flow battery degassing device provided in the present application can degas the electrolyte without influencing the normal operation of the flow battery, which helps to ensure the working efficiency of the flow battery.

In an exemplary embodiment, a single liquid tank 7 may be correspondingly provided with at least one flow battery degassing device to improve the degassing efficiency, which is not limited in the present application.

In an exemplary embodiment, the degassing pump 11 can control the vacuum degree in the degassing tank 4. For example, it may be provided with a frequency converter.

In an exemplary embodiment, the degassing pump 11 may also be configured to transport the degassed electrolyte 1 back to the liquid tank 7. In other embodiments, other structures may be provided on the liquid inlet pipe 32 to transport the degassed electrolyte 1 back to the liquid tank 7, which is not limited in the present application.

In an exemplary embodiment, the flow battery degassing device includes a switching device configured to control the flow of the electrolyte and the discharge of the gas in the flow battery degassing device.

In an exemplary embodiment, the switching device includes a first switch 3. The first switch 3 is provided on the liquid outlet pipe and configured to control the electrolyte 1 to enter the degassing tank 4. For example, the first switch may be an electrically operated valve, which is not limited in the present application.

In an exemplary embodiment, the flow battery degassing device includes a flow rate detection device configured to detect the flow rate of the electrolyte entering the degassing tank 4. The type of the flow rate detection device is not limited in the present application.

In an exemplary embodiment, the switching device further includes an outlet valve 2. The outlet valve 2 is located on the liquid outlet pipe 31 at a position near the liquid tank 7, which can prevent the electrolyte 1 from flowing out of the liquid tank 7. In the flow direction of the electrolyte 1, the outlet valve 2 may be located upstream of the first switch 3.

In an exemplary embodiment, the switching device further includes a return valve 6. The return valve 6 is located on the liquid inlet pipe 32 at a position near the liquid tank 7, which can prevent the electrolyte 1 from flowing out of the liquid tank 7.

In an exemplary embodiment, the switching device further includes a check valve 5. The check valve 5 is provided on the liquid inlet pipe. In the flow direction of the electrolyte 1, the return valve 6 may be located downstream of the check valve 5, which can prevent the degassed electrolyte 1 from flowing back to the degassing tank 4. Once the electrolyte 1 breaks through the return valve 6, the check valve 5 can prevent the electrolyte 1 from flowing to the degassing tank 4.

In an exemplary embodiment, the check valve 5 may be located downstream of the degassing pump 11 along the flow direction of the electrolyte 1.

In an exemplary embodiment, the switching device further includes an exhaust valve 12 provided above a tank opening of the degassing tank 4. The electrolyte 1 enters the degassing tank 4 from the second inlet and then flows towards the bottom of the degassing tank 4. Under the action of vacuum negative pressure, the gas dissolved into the electrolyte 1 will be precipitated and accumulate above the tank opening of the degassing tank 4. The precipitated gas can be exhausted to the outside of the degassing tank 4 through the exhaust valve 12. The degassed electrolyte 1 can flow back to the liquid tank 7 from the second outlet.

In an exemplary embodiment, the flow battery degassing device may include a control device configured to receive a gas content value of the electrolyte in the flow battery, compare it with a preset first threshold, and control the degassing pump 11 and the switching device to work to degas the electrolyte in a case that the gas content value of the electrolyte is greater than or equal to the first threshold. The first threshold may be set according to the need, which is not limited in the present application.

In an exemplary embodiment, the flow battery degassing device may include a gas detection device configured to detect the gas content value of the electrolyte in the flow battery and transmit the detected gas content value to the control device. In exemplary embodiments, the gas detection device may be, for example, a non-contact measuring instrument such as an ultrasonic sensor, a capacitive sensor, or a laser sensor, which can achieve the measurement of gas content without contacting the electrolyte. A contact measuring instrument may also be used to detect the gas content of the electrolyte, which is not limited in the present application. In other embodiments, the flow battery degassing device may not include a gas detection device and only receive the gas content value of the electrolyte detected by the gas detection device, which is not limited in the present application.

In an exemplary embodiment, the flow rate detection device can transmit the detected flow rate value of the electrolyte to the control device. The control device is further configured to control the first switch 3 to be turned off after the flow rate value of the electrolyte is greater than or equal to a first set value, thus controlling the flow rate of the electrolyte d at a single time. The first preset value may be set according to the need, which is not limited in the present application. By setting the first set value, the flow rate of the electrolyte entering the degassing tank 4 for degassing can be controlled, which helps to ensure the degassing effect without influencing the normal operation of the flow battery.

In an exemplary embodiment, the gas detection device is further configured to detect the gas content in the degassing tank 4 and transmit it to the control device. In a case that the control device determines that the gas content in the degassing tank 4 is greater than or equal to an exhaust threshold, it controls the exhaust valve 12 to be turned on to exhaust the precipitated gas to the outside of the degassing tank 4. The gas detection device may be configured to determine the gas content in the degassing tank 4 according to the pressure value, gas composition, and other parameters inside the degassing tank 4, which is not limited in the present application. The exhaust threshold may be set according to the need, which is not limited in the present application.

In an exemplary embodiment, the gas detection device for detecting the gas content in the degassing tank 4 and the gas detection device for detecting the gas content of the electrolyte in the flow battery may also be different gas detection devices. For example, a first gas detection device may be provided and configured to detect the gas content of the electrolyte in the flow battery, and a second gas detection device may be provided and configured to detect the gas content in the degassing tank 4, which is not limited in the present application.

The inventor of the present invention also has found in practice that the electrolyte of the flow battery will generate heat in the charging and discharging process, leading to an increase in the temperature of the electrolyte. In a case that the temperature of the electrolyte exceeds critical temperature, the active substances in the electrolyte will be crystallized and precipitated from the electrolyte, thus reducing the capacity of the flow battery system and leading to a decrease in performance. The critical temperature at which the active substances are caused to be precipitated from the electrolyte may vary depending on the operating environment. For example, when the temperature is between 40° C. and 45° C., the active substances may be caused to be precipitated. In addition, if the temperature of the electrolyte is too high, it will lead to an increase in the diffusion rate of the active substances in the positive and negative electrolytes, causing an imbalance in the concentration of the active substances in the positive and negative electrolytes. This will also reduce the system capacity. The diffusion of the active substances often occurs in the form of hydrates, which may cause differences in the liquid level of the positive and negative electrolytes. The higher the temperature, the faster the differentiation rate of the liquid level. Therefore, it is necessary to promptly cool the electrolyte, otherwise it will influence the operation efficiency of the flow battery.

In an exemplary embodiment, referring to FIG. 2 and FIG. 3, the flow battery degassing device further includes a heat exchange device. The heat exchange device may include a heat exchanger 9 and a refrigerant machine 10. The heat exchanger 9 can cool the electrolyte. The refrigerant machine 10 can provide a refrigerant with set temperature and flow rate to the heat exchanger 9. The refrigerant may be, for example, a cooling medium such as water. The refrigerant machine 10 may be a water chiller. The heat exchanger 9 may be provided on the flow path of the electrolyte to cool the flowing electrolyte 1. For example, the heat exchanger 9 may be provided on at least one of the liquid outlet pipe 31, the degassing tank 4, and the liquid inlet pipe 32. The position and quantity of the heat exchanger, the specific type of the refrigerant and the like are not limited in the present application.

In an exemplary embodiment, the refrigerant machine 10 may be provided with a frequency converter, which can control the temperature and flow rate of the refrigerant.

In an exemplary embodiment, the heat exchanger 9 may be provided in the degassing tank 4. The electrolyte 1 enters the degassing tank 4 from the second inlet, passes through the heat exchanger 9 and then flows to the bottom of degassing tank 4. The refrigerant machine 10 may be provided outside the degassing tank 4. The electrolyte 1 can be degassed and cooled inside the degassing tank 4, thus reducing the maintenance time and cost of the flow battery and improving the operation efficiency of the flow battery.

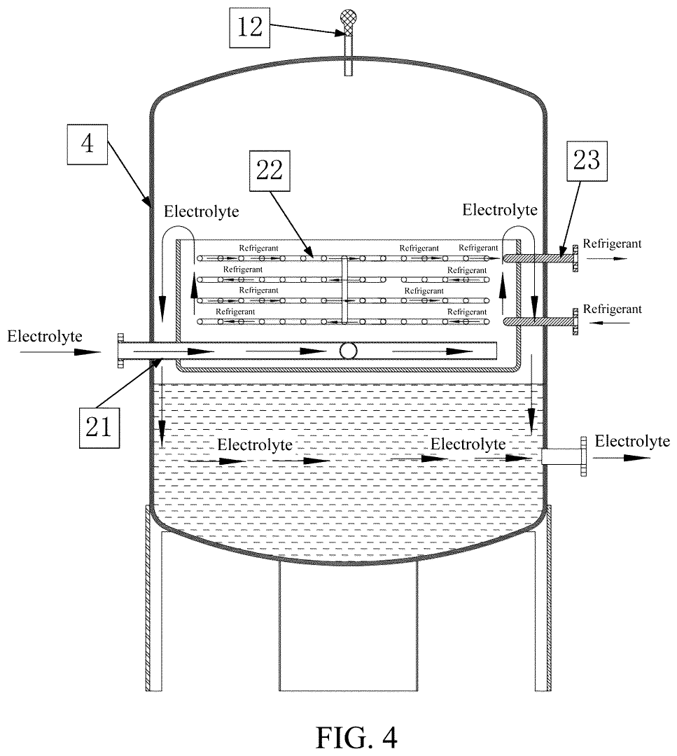

FIG. 4 illustrates a schematic diagram of a degassing tank and a heat exchanger according to an exemplary embodiment. Referring to FIG. 4, a plurality of heat exchange tubes 22 are provided in the heat exchanger 9. The plurality of heat exchange tubes 22 may be arranged in layers from bottom to top in the heat exchanger 9. A refrigerant transfer pipe 23 may be on a side surface of the heat exchanger 9. The refrigerant transfer pipe 23 is configured to be connected with the heat exchange tubes 22 and the refrigerant machine 10, so as to allow the refrigerant to flow between the heat exchange tubes 22 and the refrigerant machine 10, and to provide the refrigerant with set temperature from the refrigerant machine 10 to the heat exchange tubes 22. The bottom of the heat exchanger 9 is provided with a spray pipe 21. One end of the spray pipe 21 may be connected with the second inlet. At least one nozzle may be provided at a top of the spray pipe 21. The plurality of heat exchange tubes 22 may be located above the spray pipe 21. The electrolyte 1 can be sprayed onto the plurality of heat exchange tubes 22 through the nozzle after entering the spray pipe 21, thus achieving the cooling of the electrolyte 1.

In an exemplary embodiment, the plurality of heat exchange tubes 22 in each layer may be distributed in a mesh pattern to increase the contact area between the heat exchange tubes 22 and the electrolyte.

In an exemplary embodiment, the heat exchange tubes 22 may be capillary tubes to increase the contact area between the heat exchange tubes 22 and the electrolyte.

In an exemplary embodiment, the bottom of the heat exchanger 9 is provided with at least one liquid leakage hole to allow the electrolyte to flow out of the heat exchanger 9. Since the spray pipe 21 is located at the bottom of the heat exchanger 9, under normal circumstances, the electrolyte will flow out of the top of the heat exchanger 9 after passing through the plurality of heat exchange tubes 22 from bottom to top. In a case that the height of the electrolyte is smaller than that of the heat exchanger 9, the electrolyte will accumulate in the heat exchanger 9. The accumulated electrolyte may return to the liquid tank together with the next batch of electrolyte that enters the heat exchanger 9 for cooling. In this embodiment, by providing a liquid leakage hole at the bottom of the heat exchanger 9, the accumulated electrolyte in the heat exchanger 9 can flow from the liquid leakage hole to the bottom of the degassing tank 4. Since the electrolyte at the bottom of the degassing tank 4 is the electrolyte that has already undergone heat exchange, the electrolyte flowing out from the liquid leakage hole will not have a significant influence on the cooling effect of the electrolyte. The size of the liquid leakage hole may be set to be small to allow more electrolyte to complete the cooling and heat exchange process. However, a too small liquid leakage hole may cause the accumulated electrolyte to flow to the bottom of the degassing tank 4 for a longer time, thus increasing the cooling treatment time of the electrolyte. In practical application, the size of the liquid leakage hole may be set according to the actual need to balance the relationship between the cooling effect and the cooling treatment time, which is not limited in the present application.

In an exemplary embodiment, the size range of the liquid leakage hole may be set to be greater than or equal to 4 mm and less than or equal to 12.5 mm. For example, it may be set to be greater than or equal to 5 mm and less than or equal to 10 mm, which is not limited in the present application.

In an exemplary embodiment, the control device is further configured to receive a temperature value of the electrolyte in the flow battery, compares it with a preset second threshold, and control the heat exchange device to cool the electrolyte in a case that the temperature value is greater than or equal to the second threshold.

In an exemplary embodiment, the flow battery degassing device may include a temperature detection device configured to detect the temperature value of the electrolyte in the flow battery and transmit the detected temperature value to the control device. The specific temperature measuring means is not limited in the present application. In other embodiments, the flow battery degassing device may not include a temperature detection device and only receive the temperature value detected by the temperature detection device, which is not limited in the present application.

In an exemplary embodiment, the control device is configured to control the degassing pump 11, the switching device and the heat exchange device to work according to the received gas content and temperature values of the electrolyte.

In an exemplary embodiment, the control device is configured to use a PID algorithm to control the degassing pump 11, the switching device and the heat exchange device to work. For example, a target gas content value of the electrolyte may be set as the first threshold in advance, and a target temperature value of the electrolyte may be set as the second threshold. The target gas content value and the target temperature value may be recorded as u (t). An error between the gas content value and temperature value received by the control device and the corresponding target value may be recorded as e (t). The degassing pump 11, the switching device, and the heat exchange device are actuating mechanisms. The proportion, integral, and differential of the error may be linearly combined to form a control variable, which can be used to control the actuating mechanisms. The control device may use formula 1 to control the actuating mechanisms:

$$u ( t ) = {K}_{p} e ( t ) + {K}_{i} {\int }_{0}^{t} e ( τ ) d τ + {K}_{d} \frac{de ( t )}{d ( t )} ; \qquad ( 1 )$$

where Kp is a proportional gain, Ki is an integral gain, Kd is a differential gain, and Kp, Ki and Kd are all tuning parameters that can be set according to the actual needs; the error e is a difference between the target value and the received value; t represents current time.

The flow battery degassing device provided in the embodiment of the present application can enable the electrolyte of the flow battery to operate at ideal temperature without containing gas, and can ensure the highest charging and discharging efficiency of the flow battery. In addition, the electrolyte will not have adverse phenomena such as crystal precipitation. The single device can achieve two functions: i.e., degassing and cooling, thus reducing the maintenance time and cost of the flow battery. The control device can receive the gas content and temperature values of the electrolyte, and control the degassing pump, the switching device, and the heat exchange device to work accordingly, thus avoiding defects such as cavitation, excessive vibration, and too big noise in the electrolyte circulating pump. Moreover, the gas will not be adsorbed on the reaction interface of the stack unit, nor will it reduce the available area of the reaction interface, so that the stack is always at a relatively high operation efficiency, thus ensuring the reliability of the stack unit operation.

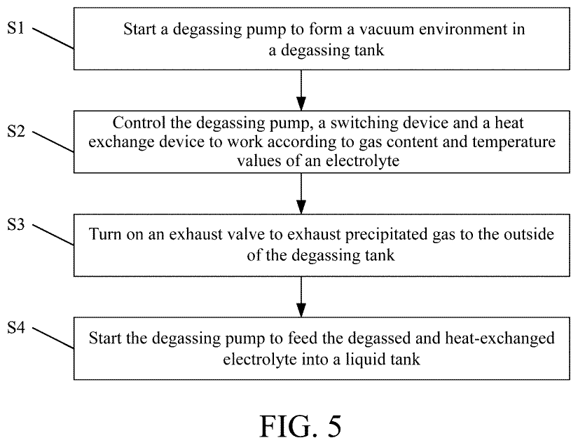

FIG. 5 illustrates a schematic diagram of a method for degassing and cooling by adopting a flow battery degassing device according to an exemplary embodiment. Referring to FIG. 5.

In S1, a degassing pump is started to form a vacuum environment in a degassing tank.

In an initial state, an outlet valve 2 and a first switch 3 are defaulted to be in an off state. After the degassing pump 11 is started, the degassing tank 4 is in a negative pressure state, which can form a set vacuum environment. The vacuum degree of the degassing tank 4 may be set according to the need, which is not limited in the present application. The control device may be used to start the degassing pump 11, or the degassing pump 11 may be manually started, which is not limited in the present application.

In S2, the degassing pump, a switching device and a heat exchange device are controlled to work according to gas content and temperature values of an electrolyte.

In an exemplary embodiment, the control device can control the degassing pump and the switching device to work in a case that the gas content of the electrolyte in the flow battery is greater than or equal to a first threshold. For example, the control device can control the outlet valve 2 and the first switch 3 to be turned on, and the electrolyte in a liquid tank 7 enters the degassing tank 4 under the action of negative pressure. In an exemplary embodiment, the control device can turn off the first switch 3 after the amount of the electrolyte entering the degassing tank 4 reaches a first set value. By controlling the flow rate of the electrolyte degassed at a single time, the degassing effect can be ensured and the influence on the operation of the flow battery can be avoided. The first preset value may be set according to the actual need, which is not limited in the present application. The switching device such as the outlet valve 2 may also be manually controlled, which is not limited in the present application.

In an exemplary embodiment, the control device can control the heat exchange device to work in a case that the temperature value of the electrolyte in the flow battery is greater than or equal to a second threshold. In an exemplary embodiment, the control device can control a refrigerant machine 10 to provide a refrigerant with different temperatures and flow rates according to the received temperature values, and can control the temperature and flow rate of the refrigerant by controlling the operation power of the refrigerant machine 10. For example, the control device can calculate a first difference between the temperature value and the second threshold. In a case that the first difference is less than or equal to 10% of the second threshold, the temperature of the refrigerant is controlled to be the first temperature and the flow rate of the refrigerant is controlled to be the first flow rate. In a case that the first difference is greater than or equal to 10% of the second threshold and less than or equal to 30% of the second threshold, the temperature of the refrigerant is controlled to be the second temperature and the flow rate of the refrigerant is controlled to be the second flow rate. Similarly, the higher the temperature value of the electrolyte, the lower the temperature of the refrigerant and the faster the flow rate can be set to improve the cooling effect. The corresponding relationship between the temperature value and the temperature and flow rate of the refrigerant may be set according to the need. For example, the temperature value may be an independent variable, the temperature and flow rate of the refrigerant may be dependent variables, and the relationship between the dependent variables and the independent variable may be different functional relationships or piecewise functions, which is not limited in the present application.

In S3, an exhaust valve is turned to exhaust precipitated gas to the outside of the degassing tank.

In combination with FIG. 4, after entering the degassing tank 4, the electrolyte can be sprayed onto heat exchange tubes 22 through a nozzle at a top of a spray pipe 21. The electrolyte moves upwards from the bottom of the heat exchanger 9 and comes into contact with the heat exchange tubes 22 during the movement. The refrigerant flowing inside the heat exchange tubes 22 can take away the heat of the electrolyte. The electrolyte flows out from the top of the heat exchanger 9 and flows to the bottom of the degassing tank 4. Under the action of liquid pressure difference and vacuum negative pressure, the gas in the electrolyte is precipitated. The control device turns on an exhaust valve 12 to exhaust the precipitated gas to the outside of the degassing tank 4.

In an exemplary embodiment, the control device can control the exhaust valve 12 to be turned on according to the operation time. For example, after detecting the electrolyte entering the degassing tank 4 for the first time, it is considered that exhausting and cooling have been completed, and the exhaust valve 12 is controlled to be turned on. Alternatively, the gas detection device is further configured to detect the gas content in the degassing tank 4 and transmit it to the control device. In a case that the control device determines that the gas content in the degassing tank 4 is greater than or equal to an exhaust threshold, it controls the exhaust valve 12 to be turned on. Alternatively, in a case that the gas content in the degassing tank 4 is greater than or equal to the exhaust threshold, the exhaust valve 12 is automatically turned on. The conditions and methods for controlling the exhaust valve to be turned on are not limited in the present application.

In S4, the degassing pump is started to feed the degassed and heat-exchanged electrolyte into a liquid tank.

After the exhaust valve 12 is turned on, the vacuum degree in the degassing tank 4 decreases. By turning on the degassing pump 11, the degassed electrolyte can be sent back to the liquid tank 7 from the second outlet. The check valve 5 can prevent the degassed electrolyte from flowing back.

After completing step S4, the degassing and cooling of the electrolyte at this time is completed, and then it can be redirected back to step S1. The control device continues to receive the gas content and temperature values of the electrolyte to determine whether next degassing and cooling are needed. The flow battery degassing device in the embodiment of the present can achieve closed-loop control.

An embodiment of the present application further provides a flow battery degassing system, which includes a flow battery and the flow battery degassing device in the embodiment above.

An embodiment of the present application further provides a flow battery degassing method. A flow battery includes a liquid tank. The method includes: using a degassing tank to form a vacuum environment in a degassing tank; controlling an electrolyte in the liquid tank to flow into the degassing tank along a liquid outlet pipe; and controlling the degassed electrolyte to flow back to the liquid tank along a liquid inlet pipe. The degassing pump is provided on the liquid inlet pipe.

The flow battery degassing method provided in the embodiment of the present application utilizes the degassing pump to form a vacuum environment in the degassing tank. The electrolyte in the liquid tank of the flow battery can enter the degassing tank, complete degassing in the vacuum environment, and return to the liquid tank, so that the gas in the electrolyte will not be adsorbed on the stack unit, thus ensuring the flow rate of the electrolyte and the charging and discharging reaction efficiency, keeping the stack unit at a relatively high operation efficiency, and ensuring the operation reliability of the stack unit. The flow battery degassing method provided in the embodiment of the present application can perform degassing treatment on the basis of normal operation of the flow battery, thus ensuring the working efficiency of the flow battery.

The flow battery degassing method provided in the embodiment of the present application is applied to the flow battery degassing device described in the embodiment above. The specific steps and effects can be found in the description of the flow battery degassing device, which will not be repeated here.

An embodiment of the present application further provides a computer-readable storage medium storing computer-executable instructions used for performing the flow battery degassing method described above.

Although the embodiments disclosed in the present application are as described above, the content described above is only intended to understand the present application, instead of limiting the present application. Any technical personnel in the field to which the present application belongs may make any modifications and changes to the form and details of implementation without departing from the spirit and scope disclosed herein.

1. A flow battery degassing device, a flow battery comprising a liquid tank, the flow battery degassing device comprising a degassing tank, a degassing pump, a liquid outlet pipe, and a liquid inlet pipe, the liquid outlet pipe being configured to enable an electrolyte in the liquid tank to flow into the degassing tank, the liquid inlet pipe being configured to enable the electrolyte in the degassing tank to flow into the liquid tank;
the degassing pump being provided on the liquid inlet pipe and configured to form a vacuum environment in the degassing tank.

2. The flow battery degassing device according to claim 1, wherein the flow battery degassing device further comprises a switching device, the switching device comprises a check valve provided on the liquid inlet pipe, and the check valve is located downstream of the degassing pump along a flow direction of the electrolyte and configured to prevent the degassed electrolyte from flowing back to the degassing tank.

3. The flow battery degassing device according to claim 2, wherein the switching device further comprises a first switch provided on the liquid outlet pipe and configured to control the electrolyte to enter the degassing tank.

4. The flow battery degassing device according to claim 3, wherein the flow battery degassing device further comprises a control device, and the control device is configured to receive a gas content value of the electrolyte in the flow battery and control the degassing pump and the switching device to work to degas the electrolyte in a case that the gas content value is greater than or equal to a first threshold.

5. The flow battery degassing device according to claim 4, wherein the flow battery degassing device further comprises a gas detection device configured to detect the gas content value of the electrolyte in the flow battery and transmit the detected gas content value to the control device.

6. The flow battery degassing device according to claim 4, wherein the flow battery degassing device further comprises a flow rate detection device configured to detect a flow rate value of the electrolyte entering the degassing tank and transmit the detected flow rate value of the electrolyte to the control device;
the control device is further configured to control the first switch to be turned off after the flow rate value of the electrolyte is greater than or equal to a first set value.

7. The flow battery degassing device according to claim 4, wherein the flow battery degassing device further comprises a heat exchange device; the heat exchange device comprises a heat exchanger and a refrigerant machine, the heat exchanger is configured to cool the electrolyte, and the refrigerant machine is configured to provide a refrigerant to the heat exchanger.

8. The flow battery degassing device according to claim 7, wherein the heat exchanger is provided in the degassing tank, and the electrolyte flows through the heat exchanger to a bottom of the degassing tank after entering the degassing tank.

9. The flow battery degassing device according to claim 7, wherein a plurality of heat exchange tubes are provided in the heat exchanger, the heat exchange tubes are connected with the refrigerant machine, and the refrigerant flows in the heat exchange tubes; a bottom of the heat exchanger is provided with a spray pipe, the electrolyte enters the heat exchanger from one end of the spray pipe, and the spray pipe is configured to enable the electrolyte to come into contact with the heat exchange tubes.

10. The flow battery degassing device according to claim 9, wherein the plurality of heat exchange tubes are arranged in layers from bottom to top in the heat exchanger.

11. The flow battery degassing device according to claim 7, wherein the control device is further configured to receive a temperature value of the electrolyte in the flow battery and control the heat exchange device to work to cool the electrolyte in a case that the temperature value is greater than or equal to a second threshold.

12. The flow battery degassing device according to claim 11, wherein the flow battery degassing device further comprises a temperature detection device configured to detect the temperature value of the electrolyte in the flow battery and transmit the detected temperature value to the control device.

13. A flow battery degassing system, comprising a flow battery and the flow battery degassing device according to claim 1.

14. A flow battery degassing method, a flow battery comprising a liquid tank, the method comprising: using a degassing tank to form a vacuum environment in a degassing tank; controlling an electrolyte in the liquid tank to flow into the degassing tank along a liquid outlet pipe; and controlling the degassed electrolyte to flow back to the liquid tank along a liquid inlet pipe, the degassing pump being provided on the liquid inlet pipe.

15. A computer-readable storage medium storing computer-executable instructions used for performing the flow battery degassing method according to claim 14.
